(19) United States
(12) Patent Application Publication
(10) Pub. No.: US 2005/0129094 A1
(43) Pub. Date: Jun. 16, 2005

(54) Communication system using wavelength spread-spectrum coding

(76) Inventors: William R. Trutna JR., Atherton, CA (US); Kenneth R. Wildnauer, Santa Rosa, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/733,675

(22) Filed: Dec. 11, 2003

(51) Int. Cl. H04B 1/69

(52) U.S. Cl. 375/146

(57) ABSTRACT

Wavelength spread-spectrum coding enables a multi-channel communication systems to transmit more information signals than the number of transmission channels. At the transmitter, each information signal is encoded with a respective spreading code to generate a coded signal corresponding to each bit of the spreading code and the coded signals corresponding to the same bit of the spreading codes are allocated to a respective transmission channel. Then, in each transmission channel, the coded signals allocated thereto are analog summed to generate a modulation signal, and a transmission signal is modulated in response to the modulation signal. In the receiver, each information signal is recovered by multiplying the channel signal from each transmission channel by a respective bit of the spreading code assigned to the information signal to generate a respective product signal, summing the product signals to generate a sum signal, and subjecting the sum signal to thresholding.

### BACKGROUND

Wavelength division multiplexing (WDM) is employed in optical communication systems to enable information signals to be transmitted at multiple wavelengths over a single optical fiber, thereby increasing the number of information signals that can be transmitted by the fiber. The theoretical minimum optical loss for glass optical fiber is about 0.16 decibels per kilometer (dB/km), and this theoretical minimum occurs at a wavelength of about 1550 nanometers (nm). Erbium-doped amplifiers, which currently are the most common type of amplifier used for amplifying optical signals carried on optical fibers, perform best in the wavelength range of approximately 1520 to 1565 nm. Therefore, these amplifiers have the best gain characteristics over a wavelength range that includes the wavelength at which optical attenuation in optical fibers is at a minimum.

FIG. 1 illustrates a graph 1 on which two curves 10 and 11 are plotted. The axis labeled FIBER LOSS (dB) of graph 1 indicates the optical loss in decibels (dB) for a typical optical fiber as a function of transmission wavelength. The axis labeled AMPLIFIER GAIN (dB) indicates the optical gain in dB of a typical erbium-doped amplifier as a function of wavelength. Curve 10 represents optical loss as a function of wavelength for a typical optical fiber. Curve 11 represents gain as a function of wavelength for a typical erbium-doped amplifier. Curves 10 and 11 are not intended to illustrate precise relationships, but illustrate an approximate relationship between the loss and gain characteristics of a typical optical fiber and a typical erbium-doped amplifier, respectively.

The shape of curve 11 in the graph 1 indicates that a typical erbium-doped amplifier has its highest gain in a wavelength range that is approximately 43 nm wide. This range includes the 1550 nm wavelength and wavelengths slightly less than and greater than 1550 nm. The shape of curve 11 also indicates that the gain of the erbium-doped amplifier drops off rapidly outside the 43 nm-wide range. The shape of curve 10 indicates that the optical fiber has its lowest optical loss at approximately 1550 nm. Therefore, optimum optical performance is obtained in an optical communication system by using transmission wavelengths in the 43 nm-wide wavelength range. Two other wavelength ranges exist that are used less commonly than the 43 nm range described above. These are the long band (L-band) and short band (S-band) wavelength ranges. For illustrative purposes, only the 43 nm-wide wavelength range at approximately 1550 nm will be discussed herein due to the fact that the majority of optical fiber communication occur in this wavelength range.

The ability of WDM to increase the capacity of optical communication systems is limited by the above-described constraint on usable transmission wavelengths and by the need for the transmission wavelengths to be spaced sufficiently in wavelength to prevent interference between the optical signals in adjacent channels. This need for wavelength spacing decreases the number of usable transmission wavelengths, and thereby further limits capacity.

In optical communication systems employing WDM, the above-mentioned 43 nm-wide wavelength range is typically divided into 80 channels, i.e., transmission wavebands, each of which carries an optical signal modulated at a bit rate of 10 Gigabits per second (Gb/s). Adjacent channels differ in center frequency by 50 Gigahertz (GHz). The 80 channels collectively occupy a frequency range of approximately 4,000 GHz, i.e., 80 channels×50 GHz. The aggregate bit rate when information signals are transmitted on all channels is 800 Gb/s, i.e., 80 channels×10 Gb/s. A good figure of merit for the spectral efficiency of an optical communication system is the bit rate divided by the bandwidth of the system. The 80-channel system, therefore, has a figure of merit equal to approximately ((80×10 Gb/s)/(4,000 GHz)) or 0.20 bits.sec⁻¹/Hz. This figure of merit is very close to the limit of what can be achieved with current WDM systems. The limit is a practical limit dictated by a number of factors including laser drift and drift of the optical filters used in the WDM demultiplexers.

Optical filters are used in the wavelength division demultiplexer of the optical receivers used in optical communication systems to separate the WDM channels at the receiver and prevent interference between the optical signals in adjacent channels. The optical filters that are currently used in such receivers have a pass bandwidth of approximately 30 GHz, which is much less than the channel spacing of 50 GHz. Wider filter bandwidths would enable the bit rate of the optical signals to be increased, but would produce unacceptable levels of inter-channel interference because of the gradual roll-off of the out-of-band rejection characteristic of the optical filters. In addition, factors such as temperature drift of both the laser frequency and the center frequency of the optical filters, aging of the filter components, etc., further reduce the possibility that the usable bandwidth of the channels can be increased by conventional approaches. The factors just described combine to limit the maximum bit rate per channel in such systems to the 10 Gb/s rate mentioned above. This bit rate is small compared with the channel spacing between the channels.

Also, in a conventional optical communication system, if the transmitter or the receiver associated with one of the information signals fails or is otherwise impaired, transmission of the information signal through the optical communication system stops until the failed component is repaired or replaced.

Accordingly, a need exists for an alternative way of increasing the transmission capacity and reliability of an optical transmission system.

### SUMMARY

In accordance with the present invention, wavelength spread-spectrum encoding is used to enable a multi-channel communication system such as a WDM optical communication system to transmit more full-bandwidth information signals than the number of channels of the communication system. In such wavelength spread-spectrum communication system, each information signal is carried by all of the channels of the communication system and each of the channels carries part of all the information signals.

Applying wavelength spread-spectrum encoding to the information signals in accordance with the invention gives the additional advantage that all of the information signals can be successfully recovered at the receiver even if one or more channels of the multi-channel communication system become inoperable or subject to high levels of interference. In other words, wavelength spread-spectrum encoding in accordance with the invention provides redundancy with respect to transmission of the information signals. Wavelength spread-spectrum encoding in accordance with the invention is suitable for use in any wired, wireless or optical multi-channel communication system.

In a first aspect, the invention provides a method for transmitting information signals via multiple transmission channels. In an embodiment of the method, each information signal is encoded with a respective spreading code to generate a coded signal corresponding to each bit of the spreading code. The spreading codes are mutually different. The coded signals corresponding to the same bit of the spreading codes are allocated to a respective transmission channel. Then, in each transmission channel, the coded signals allocated to the transmission channel are analog summed to generate a modulation signal, and a transmission signal is modulated in response to the modulation signal.

In a second aspect, the invention provides a method for recovering information signals from channel signals received via respective transmission channels. The channel signals are generated by encoding the information signals with respective spreading codes. In an embodiment of the method, each of the information signals is recovered by multiplying the channel signal from each transmission channel by a respective bit of the spreading code assigned to the information signal to generate a respective product signal, summing the product signals to generate a sum signal, and subjecting the sum signal to thresholding.

In a third aspect, the invention provides apparatus for transmitting information signals via multiple transmission channels. An embodiment of the apparatus comprises a spread-spectrum encoder for each of the information signals, a signal allocator and, in each transmission channel, an analog summer and a transmitter. Each spread-spectrum encoder comprises coded signal outputs and is operable to encode the information signal with a respective spreading code to provide a coded signal corresponding to each bit of the spreading code at a respective one of the coded signal outputs. The spreading codes are mutually different. The signal allocator is connected to the coded signal outputs of the spread-spectrum encoders and structured to allocate the coded signals corresponding to the same bit of the spreading codes to a respective one of the transmission channels. Each analog summer comprises an output, and inputs connected to the signal allocator to receive therefrom the coded signals allocated to the transmission channel. The transmitter comprises a modulation input connected to the output of the analog summer.

In a fourth aspect, the invention provides apparatus for recovering information signals from channel signals received via respective transmission channels. The channel signals are generated by encoding the information signals with respective spreading codes. An embodiment of the apparatus comprises a spread-spectrum decoder for each information signal. The spread-spectrum decoder comprises a multiplying circuit, an analog summer and a threshold circuit. The multiplier circuit is connected to receive the channel signals from the transmission channels and is for multiplying each channel signal by a respective bit of the spreading code assigned to the information signal to generate a respective product signal. The analog summer comprises an output, and inputs connected to receive the product signals from the multiplying circuit. The threshold circuit comprises an input connected to the output of the analog summer and additionally comprises an output that provides the recovered information signal.

Other features and advantages of the invention will become apparent from the following description, drawings and claims.

### BRIEF DESCRIPTION OF THE DRAWINGS

FIG. 1 is a graph illustrating a general loss versus wavelength characteristic for an optical fiber and a general gain versus wavelength characteristic for an erbium-doped amplifier.

FIG. 2 is a block diagram of an exemplary embodiment of the transmitter of a wavelength spread-spectrum communication system in accordance with the invention.

FIGS. 3A-3D are block diagrams of an exemplary embodiment of the spread-spectrum encoders of the transmitter shown in FIG. 2.

FIG. 4 is a table showing the 64 possible states of the coded signals generated by the spread-spectrum encoders of the transmitter shown in FIG. 2 in response to all 16 possible combinations of the states of four information signals.

FIG. 5 is a block diagram of an exemplary embodiment of the receiver of a wavelength spread-spectrum communication system in accordance with the invention.

FIG. 6 is a block diagram of an exemplary first embodiment of one of the spread-spectrum decoders of the receiver shown in FIG. 5.

FIG. 7 is a table showing the operation of the spread-spectrum decoders of the receiver shown in FIG. 5 in response to all 16 possible combinations of the states of the channel signals.

FIG. 8 is a block diagram of an alternative embodiment of one of the spread-spectrum encoders of the transmitter shown in FIG. 2.

FIGS. 9A and 9B are block diagrams of another alternative embodiment of two of the spread-spectrum encoders of the transmitter shown in FIG. 2.

FIG. 10 is a block diagram of an alternative embodiment of one of the spread-spectrum decoders of the receiver shown in FIG. 5.

FIG. 11 is a flow chart of an embodiment of a method in accordance with the invention for transmitting information signals via multiple transmission channels.

FIG. 12 is a flow chart of an embodiment of a method in accordance with the invention for recovering information signals from channel signals received via respective transmission channels.

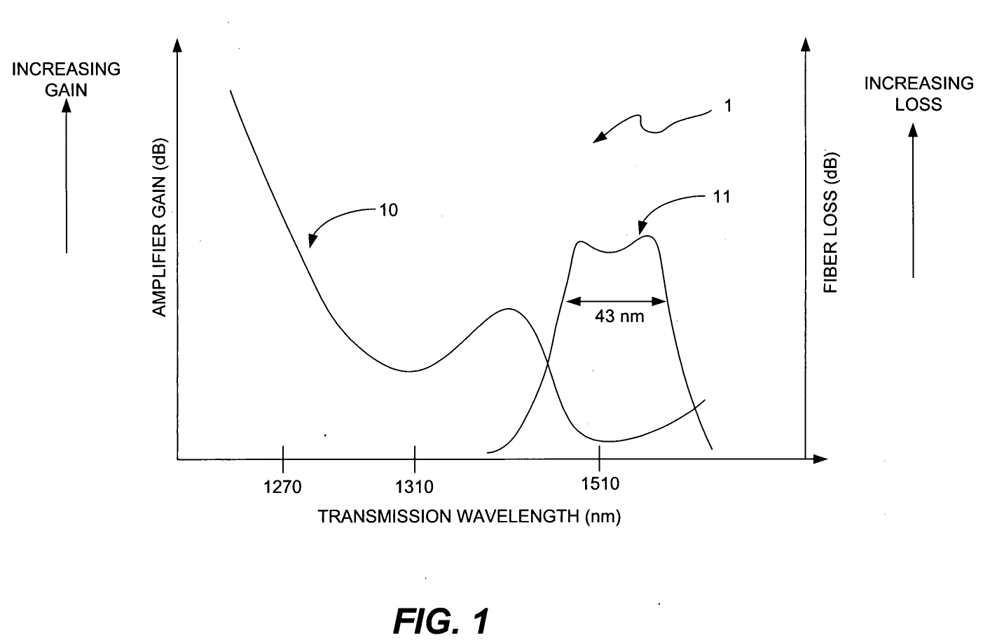

### DETAILED DESCRIPTION

In accordance with the invention, wavelength spread-spectrum encoding is used to increase the transmission capacity of a multi-channel communication system such as an optical communication system employing wavelength division multiplexing (WDM). The invention will be described below with reference to an example in which the multi-channel communication system is a WDM optical communication system. However, the invention may be applied to any type of multi-channel communication system, including wired, wireless and optical communication systems.

In accordance with the invention, each information signal is encoded with a respective spreading code to produce a coded signal corresponding to each bit of the spreading code. The spreading codes used to encode all the information signals are mutually different. The coded signals corresponding to the same bit of the spreading codes are then allocated to a respective one of the transmission channels. In each of the transmission channels, the coded signals allocated to the transmission channel are analog summed to generate a modulation signal, and a transmission signal is modulated in response to modulation signal.

In the transmitter of an exemplary WDM optical communication system employing wavelength spread-spectrum encoding, each transmission channel includes an optical transmitter in which light generated by a laser is intensity modulated in response to the modulation signal. The lasers generate light at mutually-different carrier wavelengths. The intensity of the single wavelength optical signal resulting from intensity modulating the light generated by the laser in each transmission channel represents to the analog sum of the coded signals allocated to the channel. The single-wavelength optical signals are wavelength division multiplexed to form a multi-wavelength optical signal for transmission via an optical path.

At the receiver, the multi-wavelength optical signal received from the optical path is demultiplexed according to wavelength into its constituent single-wavelength optical signals, each of which occupies a respective transmission channel. The single-wavelength optical signals are converted into respective electrical signals that will be called channel signals. The channel signals are then subject to spread-spectrum decoding to recover the original information signals. Each information signal is recovered by multiplying the channel signal from each of the transmission channels by a respective bit of the spreading code with which the information signal was encoded. The multiplying generates a product signal. The product signals are analog summed to generate a sum signal. The sum signal is subject to thresholding to recover the information signal. The other information signals are similarly recovered by multiplying the channel signals with respective bits of the spreading codes assigned to encode the respective information signals.

The channel signals subject to spread-spectrum decoding include coded components of all the information signals. However, with mutually-orthogonal spreading codes, the result of applying the multiplication and summing operations to the components coded using other spreading codes will be zero, or very close to zero. Therefore, the spread-spectrum decoding performed in each spread-spectrum decoder in the receiver recognizes and recovers only the information signal that was coded with the same spreading code as that used in the decoder.

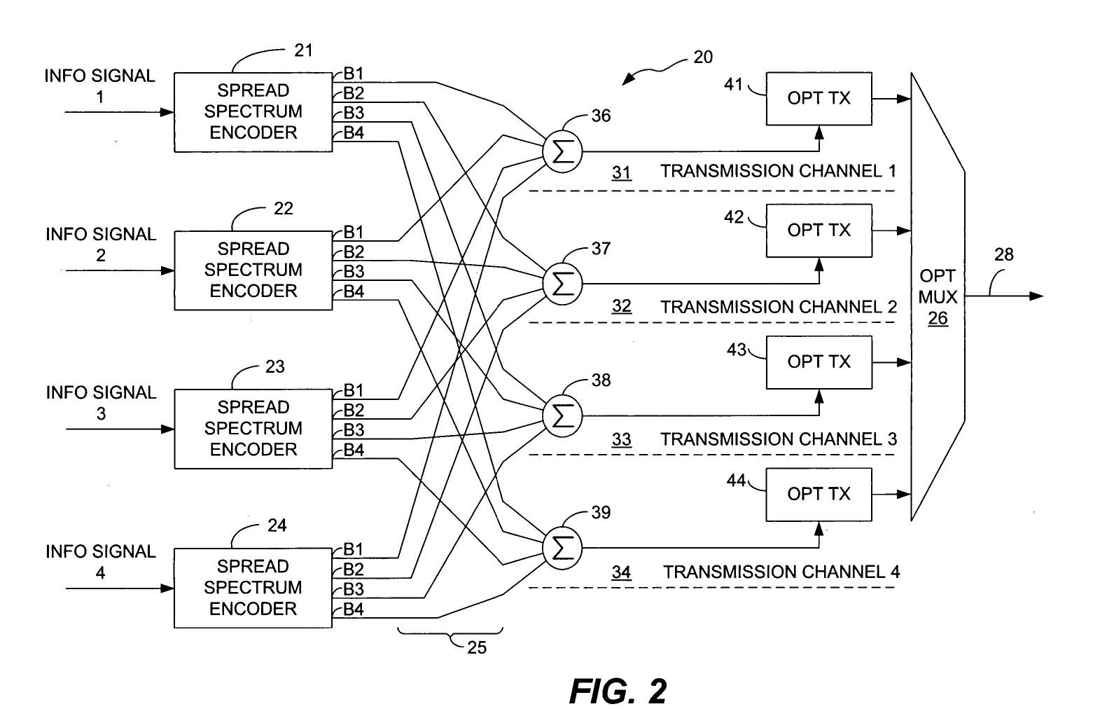

FIG. 2 is a block diagram of an exemplary embodiment of the transmitter 20 of a multi-channel communication system in which wavelength spread-spectrum encoding is applied in accordance with the invention. The example shown is highly simplified in that it transmits only four information signals using four transmission channels. Practical examples transmit substantially more than four information signals using substantially more than four transmission channels. In embodiments using quasi-orthogonal spreading codes, the transmission channels are fewer in number than the information signals so that the communication system will have a greater figure of merit than a conventional communication system in which each information signal is transmitted in its own transmission channel.

Transmitter 20, in accordance with this embodiment, is composed of spread-spectrum encoders 21, 22, 23 and 24 that apply spread-spectrum encoding to information signal 1, information signal 2, information signal 3 and information signal 4, respectively. The transmitter is additionally composed of a signal allocating circuit 25, transmission channels 31, 32, 33 and 34 and an optical multiplexer 26. Transmission channel 31 is composed of an analog summer 36 and an optical transmitter 41 connected in series. Transmission channel 32 is composed of an analog summer 37 and an optical transmitter 42 connected in series. Transmission channel 33 is composed of an analog summer 38 and an optical transmitter 43 connected in series. Transmission channel 34 is composed of an analog summer 39 and an optical transmitter 44 connected in series. Each of the optical transmitters 41, 42, 43 and 44 incorporates a laser (not shown). The lasers of the optical transmitters generate light at mutually-different wavelengths.

Each of the spread-spectrum encoders 21, 22, 23 and 24 encodes the information signal it receives with a spreading code assigned to it to generate coded signals equal in number to the number of bits in the spreading codes, as will be described in detail below. The coded signals are output by the spread-spectrum encoders 21-24 at coded signal outputs labelled B1, B2, B3 and B4. The coded signals will be identified herein by the letter S and a number corresponding to the number of the coded signal output of the spread-spectrum encoder at which it is output. Thus, coded signals S1, S2, S3 and S4 are output by the spread-spectrum encoders at coded signal outputs B1, B2, B3 and B4, respectively.

Each of the analog summers 36-39 has four inputs. Signal allocating circuit 25 has 16 inputs and 16 outputs. Four of the inputs of signal allocating circuit 25 are connected to the coded signal outputs B1 of spread-spectrum encoders 21-24. These four inputs connect to four of the outputs that are connected to the inputs of analog summer 36. Another four of the inputs of the signal allocating circuit are connected to the coded signal outputs B2 of the spread-spectrum encoders. These four inputs connect to another four of the outputs that are connected to the inputs of analog summer 37. Another four of the inputs of the signal allocating circuit are connected to the coded signal outputs B3 of the spread-spectrum encoders. These four inputs connect to another four of the outputs that are connected to the inputs of analog summer 38. A final four of the inputs of the signal allocating circuit are connected to the coded signal outputs B4 of the spread-spectrum encoders. These four inputs connect to a final four of the outputs that are connected to the inputs of analog summer 38. Thus, signal allocating circuit 25 allocates to transmission channel 31 the coded signals S1 generated by encoding information signals 1, 2, 3 and 4 with respective spreading codes. Similarly, signal allocating circuit 25 allocates the coded signals S2 generated by encoding information signals 1, 2, 3 and 4 with the respective spreading codes to transmission channel 32, the coded signals S3 generated by encoding information signals 1, 2, 3 and 4 with the respective spreading codes to transmission channel 33 and the coded signals S4 generated by encoding information signals 1, 2, 3 and 4 with respective spreading codes to transmission channel 34.

In transmission channel 31, analog summer 36 analog sums the four coded signals S1 generated by encoding the information signals 1, 2, 3 and 4 to generate a respective modulation signal. The output of analog summer 36 is connected to the modulation input of optical transmitter 41. The modulation signal output by analog summer 36 modulates the intensity of the light generated by the laser (not shown) of optical transmitter 41 to provide a single-wavelength optical signal as the output of transmission channel 31.

In transmission channel 32, analog summer 37 sums the coded signals S2 generated by encoding the information signals 1, 2, 3 and 4 to generate a respective modulation signal. The output of analog summer 37 is connected to the modulation input of optical transmitter 42. The modulation signal generated by analog summer 37 modulates the intensity of the light output by the laser (not shown) of optical transmitter 42 to provide a single-wavelength optical signal as the output of transmission channel 32.

In transmission channel 33, analog summer 38 sums the coded signals S3 generated by encoding the information signals 1, 2, 3 and 4 to generate a respective modulation signal. The output of analog summer 38 is connected to the modulation input of optical transmitter 43. The modulation signal generated by analog summer 38 modulates the intensity of the light generated by the laser (not shown) of optical transmitter 43 to provide a single-wavelength optical signal as the output of the transmission channel 33.

In transmission channel 34, analog summer 39 sums the coded signals S4 generated by encoding the information signals 1, 2, 3 and 4 to generate a respective modulation signal. The output of analog summer 39 is connected to the modulation input of optical transmitter 44. The modulation signal generated by analog summer 39 modulates the intensity of the light generated by the laser (not shown) of optical transmitter 44 to provide a single-wavelength optical signal as the output of the transmission channel 34.

The intensity of the light generated by the lasers (not shown) of optical transmitters 4144 is modulated by modulating the drive current to the laser in response to the modulation signal. Alternatively, the intensity of the light may be modulated by passing the light generated by the laser through a modulator that operates in response to the modulation signal.

The intensity-modulated single-wavelength optical signals output by transmission channels 31-34 pass to optical multiplexer 26. Optical multiplexer 26 has inputs connected to the outputs of optical transmitters 41-44 and multiplexes the single-wavelength optical signals generated by the optical transmitters to form a multi-wavelength optical signal for transmission via a single optical transmission path 28 connected to the output of the optical multiplexer. Typically, an optical fiber provides the optical transmission path 28.

Each of the spread-spectrum encoders 21, 22, 23 and 24 encodes the information signal it receives with a spreading code assigned to it. The spreading codes assigned to spread-spectrum encoders 21-24 are mutually different. In the example shown, the spreading codes are mutually orthogonal. Alternatively, the spreading codes may be mutually quasi-orthogonal.

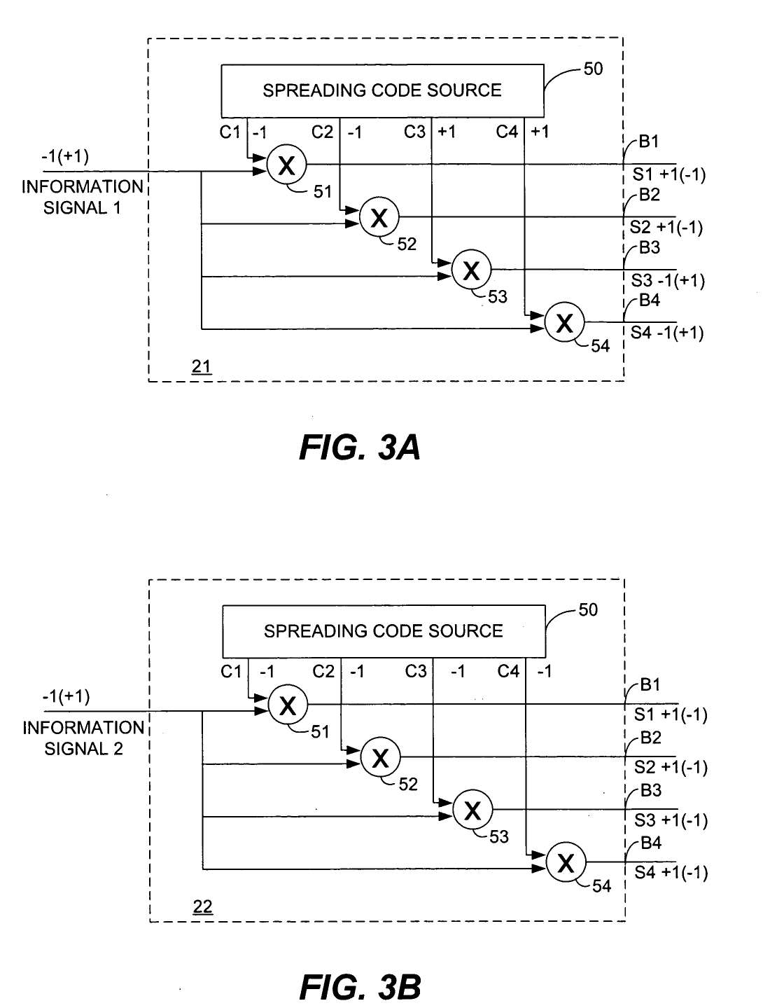

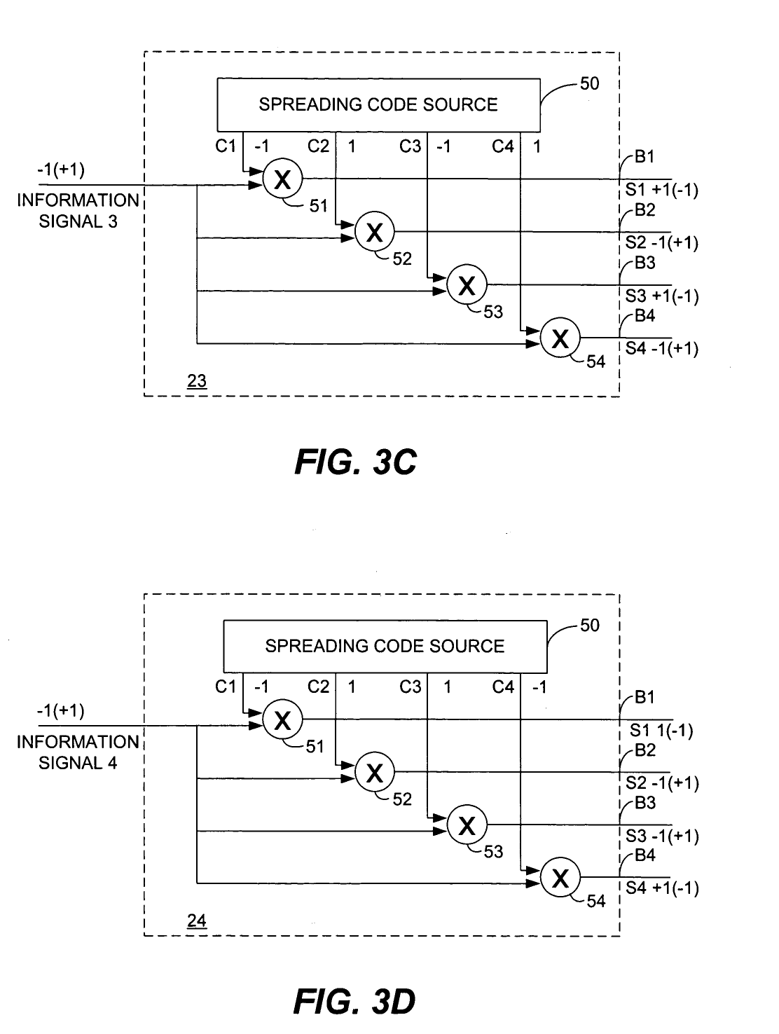

FIG. 3A is a block diagram of an exemplary embodiment of spread-spectrum encoder 21 that encodes information signal 1. Spread-spectrum encoder 21 is composed of a spreading code source 50 and multipliers 51, 52, 53 and 54. The spreading code source has outputs each of which provides a respective bit of the spreading code assigned to spread-spectrum encoder 21. The bits of the spreading code will be identified as C1, C2, C3 and C4 in this example in which the spreading codes each have four bits.

One input of each of the multipliers 51-54 is connected to receive the information signal 1. The other inputs of the multipliers 51, 52, 53 and 54 are connected to the outputs of spreading code source 50 to receive bit C1, bit C2, bit C3 and bit C4, respectively, of the spreading code assigned to spread-spectrum encoder 21. The outputs of the multipliers 51, 52, 53 and 54 are connected to the coded signal outputs B1, B2, B3 and B4, respectively, of spread-spectrum encoder 21. The outputs of the multipliers 51, 52, 53 and 54 provide the coded signals S1, S2, S3 and S4, respectively, generated by spread-spectrum encoder 21.

Multipliers 51, 52, 53 and 54 multiply information signal 1 by bit C1, bit C2, bit C3 and bit C4, respectively, of the spreading code received from spreading code source 50. The multiplication by multipliers 51, 52, 53 and 54 generates the four coded signals S1, S2, S3 and S4, respectively, that collectively represent information signal 1. The coded signals are output by spread-spectrum encoder 21 at coded signal outputs B!, B2, B3 and B4, respectively.

The remaining spread-spectrum encoders 22-24 are shown in FIGS. 3B-3D and are structurally identical to spread-spectrum encoder 21 except for the spreading code output by spreading code source 50. FIGS. 3A-3D also show two consecutive states of the coded signals S1-S4 that each spread-spectrum encoder 21-24 generates in response to two consecutive bits of the respective information signal. The consecutive bits are in a −1 state and a +1 state. The bits of the information signals in the +1 state and the states of the coded signals generated in response to the bits of the information signals in the +1 state are shown in parentheses.

The way in which the transmitter 20 applies wavelength spread-spectrum encoding to information signals 1, 2, 3 and 4 will be described with reference to the simplified example shown in FIGS. 2, and 3A-3D, which uses 4-bit spreading codes. The only mutually-orthogonal 4-bit spreading codes are spreading code 1: {−1,−1,+1,+1}; spreading code 2: {−1,−1,−1,−1}; spreading code 3: {−1,+1,−1,+1}; spreading code 4: {−1,+1,+1,−1}. The orthogonality of two spreading codes is defined by taking the discrete cross-correlation of the spreading codes. If w_{q} and x_{q} are the qth elements of two L-bit bipolar spreading codes wand x, then the cross-correlation of any two of the spreading codes may be determined by the operation:

$${y}_{k} ≡ {w}_{k} * {x}_{k} = {\sum }_{m = 0}^{L - 1} {w}_{m} {x}_{m + k} ,$$

where wₖ and xₖ have non-zero values between 0 and L−1 inclusive. The cross-correlation y has length 2L−1 running from 1-L to L−1. To define orthogonality, the only term of interest is the zero offset term (k=0). The two spreading codes are orthogonal if the zero-offset cross-correlation is zero (y₀=0). The autocorrelation is defined by xₖ*xₖ is always L for bipolar L-bit spreading codes.

The mutual orthogonality of spreading code 1={−1,−1,+1,+1}, spreading code 2={−1,−1,−1,−1}, spreading code 3={−1,+1,−1,+1,−1} and spreading code 4={−1,+1,+1,−1} may be confirmed by direct substitution of the spreading codes into the cross-correlation formula set forth above.

In accordance with the invention, for each information signal to be transmitted, the information signal is encoded with the spreading code assigned to encode the information signal to generate a coded signal corresponding to each bit of the spreading code. Then, the coded signals corresponding to the same bit of the spreading codes are assigned to a respective one of the transmission channels. In each transmission channel, the coded signals allocated to the channel are analog summed to provide a modulation signal and a transmission signal is modulated in response to the modulation signal. For example, to transmit a bit of an information signal encoded with a four-bit spreading code needs four transmission channels.

Spreading code 1 is assigned to encode information signal 1 and is stored in code word source 50 of spread-spectrum encoder 21 shown in FIGS. 2 and 3A. Spreading code 2 is assigned to encode information signal 2 and is stored in code word source 50 of spread-spectrum encoder 22 shown in FIGS. 2 and 3B. Spreading code 3 is assigned to encode information signal 3 and is stored in the code word source of spread-spectrum encoder 23 shown in FIGS. 2 and 3C. Spreading code 4 is assigned to encode information signal 4 and is stored in the code word source of spread-spectrum encoder 24 shown in FIGS. 2 and 3D.

Referring to FIG. 3A, in spread-spectrum encoder 21 for information signal 1, multipliers 51, 52, 53 and 54 multiply information signal 1 by the four bits {C1=−1, C2=−1, C3=+1, C4=+1}, respectively, of spreading code 1 to generate the four coded signals S1, S2, S3 and S4, respectively. For each bit of information signal 1 in the −1 state, multipliers 51, 52, 53 and 54 generate coded signals S1, S2, S3 and S4 with states +1,+1,−1 and −1, respectively. For each bit of information signal 1 in the +1 state, multipliers 51, 52, 53 and 54 generate coded signals S1, S2, S3 and S4 with states −1,−1,+1 and +1, respectively. Spread-spectrum encoder 21 outputs to signal allocator 25 coded signals S1, S2, S3 and S4 with states +1,+1,−1 and −1, respectively for each bit of information signal 1 in the −1 state and with states −1,−1,+1 and +1, respectively, for each bit of information signal 1 in the +1 state.

Referring now to FIG. 3B, in spread-spectrum encoder 22 for information signal 2, multipliers 51, 52, 53 and 54 multiply information signal 2 by the four bits {C1=−1, C2=−1, C3=−1, C4=−1}, respectively, of spreading code 2 to generate the four coded signals S1, S2, S3 and S4, respectively. For each bit of information signal 2 in the −1 state, multipliers 51, 52, 53 and 54 generate coded signals S1, S2, S3 and S4 with states +1,+1,+1 and +1, respectively. For each bit of information signal 2 in the +1 state, multipliers 51, 52, 53 and 54 generate coded signals S1, S2, S3 and S4 with states −1,−1,−1, and −1, respectively. Spread-spectrum encoder 22 outputs to signal allocator 25 coded signals S1, S2, S3 and S4 with states +1,+1,+1 and +1, respectively for each bit of information signal 2 in the −1 state and with states −1,−1,−1 and −1, respectively, for each bit of information signal 2 in the +1 state.

Referring now to FIG. 3C, in spread-spectrum encoder 23 for information signal 3, multipliers 51, 52, 53 and 54 multiply information signal 3 by the four bits {C1=−1, C2=+1, C3=−1, C4=+1}, respectively, of spreading code 3 to generate four coded signals S1, S2, S3 and S4, respectively. For each bit of information signal 3 in the −1 state, multipliers 51, 52, 53 and 54 generate coded signals S1, S2, S3 and S4 with states +1,−1,+1 and −1, respectively. For each bit of information signal 3 in the +1 state, multipliers 51, 52, 53 and 54 generate coded signals S1, S2, S3 and S4 with states −1,+1,−1 and +1, respectively. Spread-spectrum encoder 23 outputs to signal allocator 25 coded signals S1, S2, S3 and S4 with states +1,−1,+1 and −1, respectively for each bit of information signal 3 in the −1 state and with states −1,+1,−1 and +1, respectively, for each bit of information signal 3 in the +1 state.

Referring now to FIG. 3D, in spread-spectrum encoder 24 for information signal 4, multipliers 51, 52, 53 and 54 multiply information signal 4 by the four bits {C1=−1, C2=+1, C3=+1, C4=−1}, respectively, of spreading code 4 to generate four coded signals S1, S2, S3 and S4, respectively. For each bit of information signal 4 in the −1 state, multipliers 51, 52, 53 and 54 generate coded signals S1, S2, S3 and S4 with states +1,−1,−1 and +1, respectively. For each bit of information signal 3 in the +1 state, multipliers 51, 52, 53 and 54 generate coded signals S1, S2, S3 and S4 with states −1,+1,+1 and −1, respectively. Spread-spectrum encoder 24 outputs to signal allocator 25 coded signals S1, S2, S3 and S4 with states +1,−1,−1 and +1, respectively for each bit of information signal 4 in the −1 state and with states −1,+1,+1 and −1, respectively, for each bit of information signal 4 in the +1 state.

Referring again to FIG. 2, signal allocator 25 connects the outputs B1 of spread-spectrum encoders 21, 22, 23 and 24 to the inputs of analog summer 36 in transmission channel 31. Analog summer 36 generates a modulation signal whose level is the analog sum of the coded signals S1 received from the spread-spectrum encoders. The signal allocator also connects the outputs B2 of spread-spectrum encoders 21, 22, 23 and 24 to the inputs of analog summer 37 in transmission channel 32. Analog summer 37 generates a modulation signal whose level is the analog sum of the coded signals S2 received from the spread-spectrum encoders. The signal allocator also connects the ouputs B3 of spread-spectrum encoders 21, 22, 23 and 24 to the inputs of analog summer 38 transmission channel 33. Analog summer 38 generates a modulation signal whose level is the analog sum of the coded signals S3 received from the spread-spectrum encoders. The signal allocator connects the outputs B4 of spread-spectrum encoders 21, 22, 23 and 24 to the inputs of analog summer 39 in transmission channel 34. Analog summer 39 generates a modulation signal whose level is the analog sum of the coded signals S4 received from the spread-spectrum encoders.

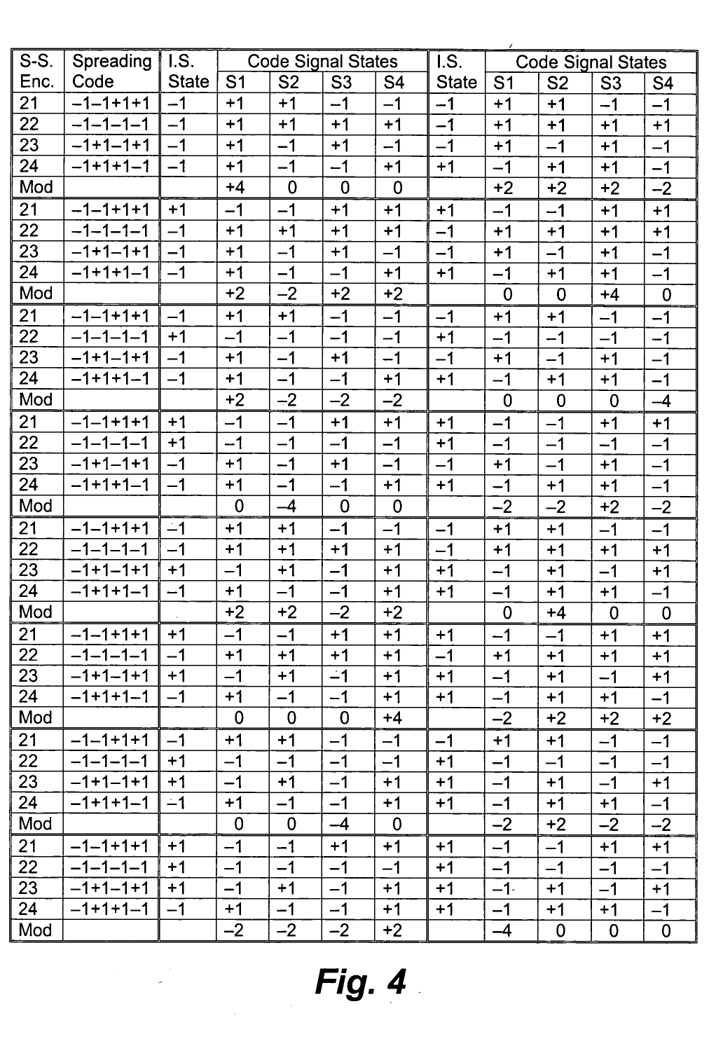

FIG. 4 is a table showing the 64 possible states of the coded signals generated by spread-spectrum encoders 21, 22, 23 and 24 in response to all 16 possible combinations of the states of the information signals 1-4. FIG. 4 is divided by vertical double lines into three columnar panels. The panels are divided by horizontal double lines into blocks each of which shows one combination of the states of the information signals. The left-hand columnar panel indicates the reference numerals of the spread-spectrum encoders in a column labelled S-S Enc. and the spreading code assigned to each spread-spectrum encoder in a column labelled Spread. Code. The center panel shows, in columns labelled S1 through 54, the states of the coded signal indicated by the label generated by the spread-spectrum encoders for each combination of states of information signals 1-4 in the range −1−1−1−1 through −1+1+1+1. The states of the information signals are shown in a column labelled IS. State. The center panel also shows, in a row labelled Mod, the level of the modulation signal obtained by analog summing the four coded signal states shown in the same column. The right-hand panel shows, in columns labelled S1 through S4, the states of the coded signal indicated by the label generated by the spread-spectrum encoders for each combination of states of information signals 1-4 in the range +1−1−1−1 through +1+1+1+1. The states of the information signals are shown in a column labelled IS. State. The right-hand panel also shows, in a row labelled Mod, the level of the modulation signal obtained by analog summing the four coded signal states shown in the same column.

Referring additionally to FIG. 2, in an example in which the combination of states of information signals 1-4, respectively, is {−1,−1,+1,−1}, the states of coded signals S1-S4 generated by spread-spectrum encoders 21, 22, 23 and 24, respectively, are {+1,+1,−1,−1}, {+1,+1,+1,+1}, {−1,+1,−1,+1} and {1,−1,−1,+1}, respectively. The states of the coded signals are shown in order from coded signal S1 through coded signal S4.

Analog summer 36 receives the states {−1,−1,+1,−1} of coded signals S1 from spread-spectrum encoders 21, 22, 23 and 24, respectively. Analog summer 36 generates a modulation signal whose level is the analog sum of the states of coded signals S1. In this example, the modulation signal output by analog summer 36 has a level of (1+1−1+1)=2. Analog summer 37 receives the states {+1,+1,+1,−1} of coded signals S2 from spread-spectrum encoders 21, 22, 23 and 24, respectively. Analog summer 37 generates a modulation signal whose level is the analog sum of the states of the coded signals S1. In this example, the modulation signal output by analog summer 37 has a level of (+1+1+1−1)=2. Analog summer 38 receives the states {+1,+1,−1,−1} of coded signals S3 from spread-spectrum encoders 21, 22, 23 and 24, respectively. Analog summer 38 generates a modulation signal whose level is the analog sum of the states of coded signals S3. In this example, the modulation signal output by analog summer 38 has a level of (−1+1−1−1)=−2. Analog summer 38 receives the states {−1,+1,+1,+1} of coded signals S4 from spread-spectrum encoders 21, 22, 23 and 24, respectively. Analog summer 39 generates a modulation signal whose level is the analog sum of the states of the coded signals S4. In this example, the modulation signal output by analog summer 39 has a level of (−1+1+1+1)=2.

In transmission channel 31, the modulation signal generated by analog summer 36 is fed to the modulation input of optical transmitter 41 where it sets the single-wavelength optical signal output by optical transmitter 41 to an intensity representing a transmission signal level of +2. In transmission channel 32, the modulation signal generated by analog summer 37 is fed to the modulation input of optical transmitter 42 where it sets the single-wavelength optical signal output by optical transmitter 42 to an intensity representing a transmission signal level of +2. In transmission channel 33, the modulation signal generated by analog summer 38 is fed to the modulation input of optical transmitter 43 where it sets the single-wavelength optical signal output by optical transmitter 43 to an intensity representing a transmission signal level of −2. In transmission channel 34, the modulation signal generated by analog summer 39 is fed to the modulation input of optical transmitter 44 where it sets the single-wavelength optical signal output by optical transmitter 44 to an intensity representing a transmission signal level of +2.

Since light cannot have a negative intensity, the modulation signals do not directly modulate the intensity of the single-wavelength optical signals generated by optical transmitters 41-44. Instead, the optical transmitters each incorporate a level coder (not shown) that converts the bipolar range of levels of the modulation signals generated by analog summers 31-34 to a unipolar range of levels that set the intensity of the single-wavelength optical signal output by the optical transmitter. In one embodiment, the level coder increases the level of the modulation signal by four to convert the −4 to +4 range of the modulation signal to a range of 0 to +8. In this case, the single-wavelength optical signal output by the optical transmitter has possible intensities of 0, +2, +4, +6 and +8. In another embodiment, the coder increases each negative level of the modulation signal by five to convert the −4 to +4 range in steps of two of the modulation signal to a range of 0 to +4 in steps of one. In this case, the single-wavelength optical signal output by the optical transmitter has possible intensities of 0, +1, +2, +3 and +4. Thus, the single-wavelength optical signals output by the optical transmitters 41-44 of the transmission channels 31-34, respectively, have intensities dependent on the levels of the modulation signals output by the analog summers 36-39, respectively. In the above description, the levels of the modulation signals and the intensities of the single-wavelength optical signals are expressed in respective arbitrary units.

Optical multiplexer 26 multiplexes the single-wavelength optical signals output by the transmission channels 31, 32, 33 and 34 to generate a WDM optical signal for transmission via transmission path 28. Transmission path 28 transmits the WDM optical signal to a wavelength spread-spectrum receiver (not shown in FIG. 2) at its distal end.

Embodiments of transmitters 41-44 that generate an electrical signal for transmission via transmission path 28 are typically capable of modulation in response to a negative modulation signal, and so can be directly modulated by the modulation signals generated by analog summers 31-34. Moreover, such embodiments may employ modulation schemes other than the intensity modulation scheme exemplified above.

In the above-described examples, analog summers 31-34 sum the −1 and +1 states of coded signals S1-S4 with a weight of 1. However, this is not critical to the invention. The analog summers may alternatively sum the −1 and +1 states of the coded signals with a weight different from 1 to generate the modulation signal with a dynamic range compatible with the dynamic range requirements of optical transmitters 41-44. In the example described above, embodiments of analog summers 31-34 that sum the −1 and +1 states of the coded signals with a weight of ¼ will generate the modulation signals with a dynamic range from −1 to +1.

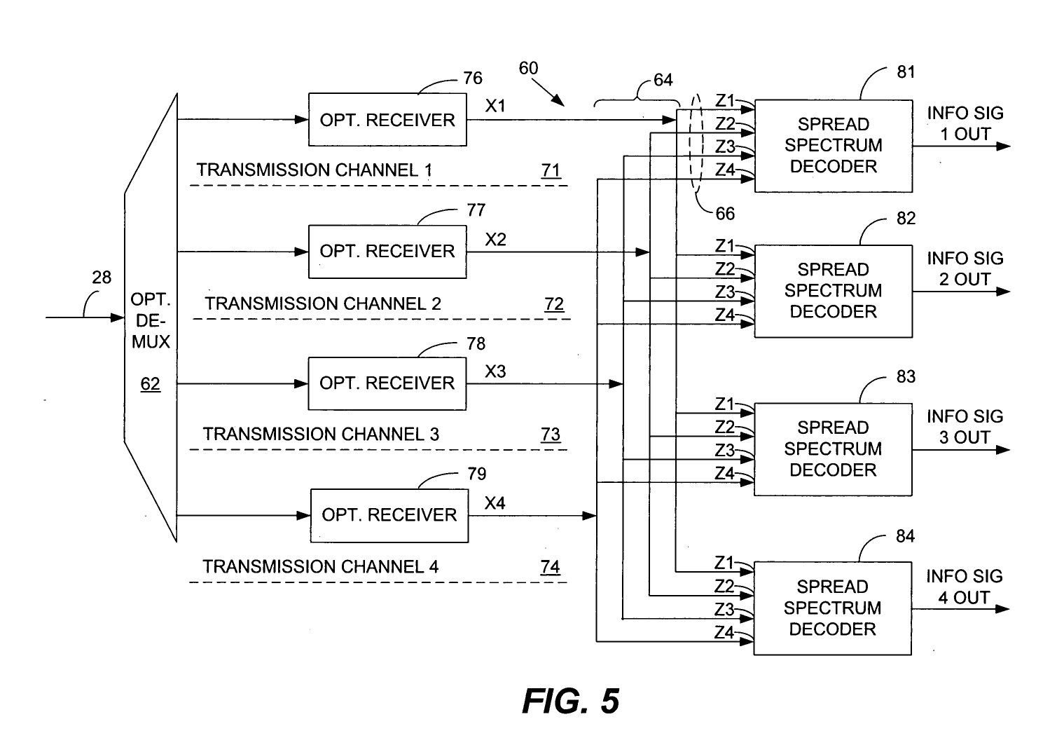

FIG. 5 is a block diagram of an exemplary embodiment 60 of the receiver of a wavelength spread-spectrum communication system in accordance with the invention. As with the wavelength spread-spectrum transmitter described above with reference to FIG. 2, the wavelength spread-spectrum receiver is a highly simplified example with only four transmission channels. A practical embodiment would receive optical signals in more than the four transmission channels shown and would recover information signals substantially greater in number than the transmission channels.

Receiver 60 is composed of an optical demultiplexer 62, a channel signal distributor 64, transmission channels 71, 72, 73 and 74 and spread-spectrum decoders 81, 82, 83 and 84. Receiver 60 is additionally composed of optical receivers 76, 77, 78 and 79 located in transmission channels 71, 72, 73 and 74, respectively.

Optical demultiplexer 62 located at the end of optical transmission path 28 remote from transmitter 20 described above with reference to FIG. 2. The optical demultiplexer receives the WDM optical signal from optical transmission path 28 and demultiplexes the WDM optical signal into its constituent single-wavelength optical signals.

Optical demultiplexer 62 has an optical output through which it delivers a respective one of the single-wavelength optical signals to each the transmission channels 71, 72, 73 and 74. Each of the transmission channels 71, 72, 73 and 74 has an optical receiver 76, 77, 78 and 79, respectively, optically coupled to a respective one of the outputs of optical demultiplexer 62. Each of the optical receivers 76-79 receives the single-wavelength optical signal delivered to the respective one of transmission channels 71-74 and converts the single-wavelength optical signal to an analog electrical signal that will be called a channel signal. Each of the optical receivers 76-79 typically includes a photodiode (not shown) or some other suitable device to effect the above-described optical-to-electrical conversion.

Each of the optical receivers 76, 77, 78 and 79 additionally includes a level decoder (not shown) that converts the unipolar analog electrical signal generated by the photo-diode (not shown) to a bipolar analog electrical signal having a range of levels that corresponds to the range of levels of the modulation signal generated by the corresponding one of the analog summers 36-39 (FIG. 2) of transmitter 20 (FIG. 2). In an example, the level decoder converts a unipolar analog electrical signal having levels ranging from 0 to +8 to a bipolar analog electrical signal having levels ranging from −4 to +4.

Referring additionally to FIG. 2, the levels of the analog electrical signals respectively output by the optical receivers 76-79 are proportional to the levels of the modulation signals in the corresponding one of the transmitter channels 31-34 of transmitter 20. Thus, the analog electrical signal output by optical receiver 76 represents the analog sum of the coded signals S1 generated by the analog summer 31 and will be called the channel signal X1; the analog electrical signal output by optical receiver 77 represents the analog sum of the coded signals S2 generated by the analog summer 32 and will be called the channel signal X2; the analog electrical signal output by optical receiver 78 represents the analog sum of the coded signals S3 generated by the analog summer 33 and will be called the channel signal X3 and the analog electrical signal output by the optical receiver 79 represents the analog sum of the coded signals S4 generated by the analog summer 34 and will be called the channel signal X4. Channel signal X1, channel signal X2, channel signal X3 signal and channel signal X4 signal are referred to collectively as channel signals. Each of the channel signals is composed of concatenated temporal segments each having a temporal duration equal to the bit period of information signals 1 through 4.

The output of each of the optical receivers 76-79 is connected to a respective one of the inputs of the channel signal distributor 64. The channel signal distributor is a four-in, 16-out distribution circuit. The four inputs of the channel signal distributor receive the channel signal X1 from optical receiver 76, the channel signal X2 from optical receiver 77, the channel signal X3 from optical receiver 78 and the channel signal X4 from optical receiver 79. The outputs of the channel signal distributor are divided into groups of four, an exemplary one of which is shown at 66. Each input of the channel signal distributor is connected to a different one of the outputs in each group of four outputs. Each of the spread-spectrum decoders 81-84 has four channel signal inputs labelled Z1, Z2, Z3 and Z4. The electrical inputs of each spread-spectrum decoder are electrically connected to a respective one of the groups of four outputs of channel signal distributor 64, with the inputs Z1, Z2, Z3 and Z4 each connected to a respective output in the group of four outputs. Accordingly, the four electrical inputs of each spread-spectrum decoder collectively receive all the channel signals.

Each of the spread-spectrum decoders 81-84 decodes one of the information signals represented by the four channel signals received at its inputs Z1-Z4. Each of the spread-spectrum decoders has assigned to it the spreading code that was used to encode a respective one of the information signals. Each spread-spectrum decoder decodes the information signal whose spreading code is assigned to it by multiplying the channel signals X1 through X4 by the corresponding bit C1 through C4 of the spreading code assigned to it to generate respective product signals. The four product signals are then analog summed to generate a sum signal. The sum signal is then subject to thresholding to convert it into a digital signal. The digital signal is logically identical to the information signal that was encoded using the spreading code assigned to the spread-spectrum decoder and is output as a recovered information signal.

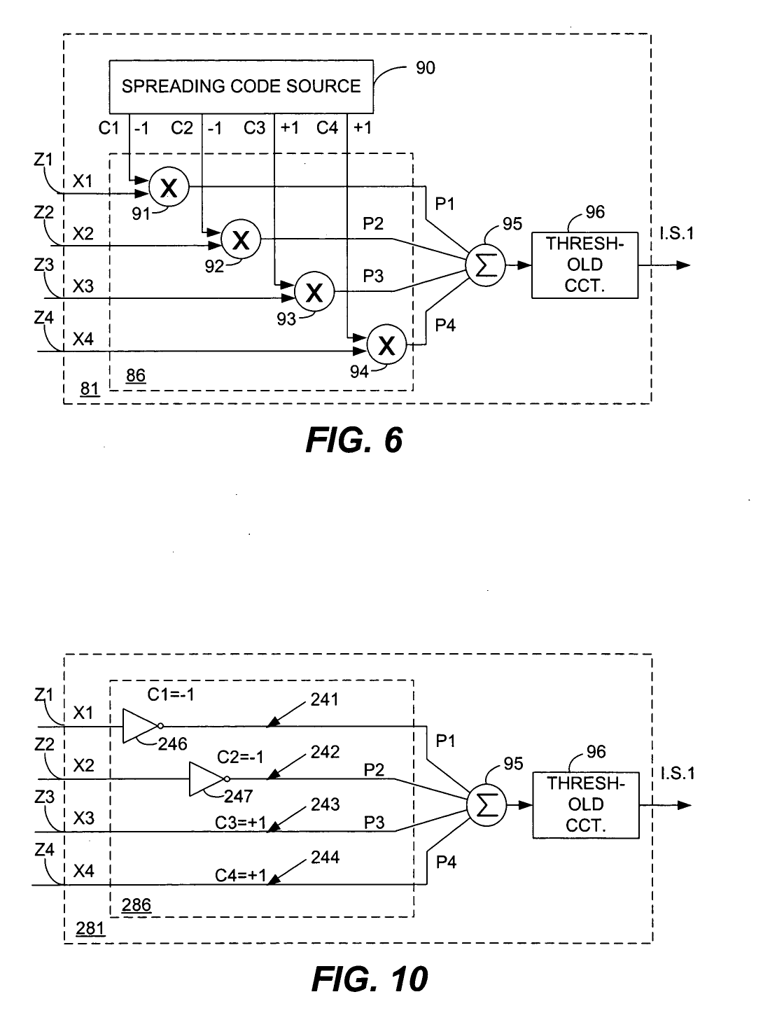

FIG. 6 is a block diagram of an exemplary first embodiment of spread-spectrum decoder 81 of the receiver shown in FIG. 5. The spreading code that was used to encode information signal 1 in transmitter 20 (FIG. 2) is assigned to spread-spectrum decoder 81. Spread-spectrum decoder 81 is composed of a multiplying circuit 86, a spreading code source 90, an analog summer 95 and threshold circuit 96. The spreading code source has outputs each providing a respective bit C1, C2, C3 and C4 of the spreading code assigned to spread-spectrum decoder 81.

Multiplying circuit 86 is connected to the inputs Z1, Z2, Z3 and Z4 of spread-spectrum decoder 81 to receive the channel signals X1, X2, X3 and X4 from transmission channels 71, 72, 73 and 74, respectively, and performs the function of multiplying each channel signal by a respective bit C1, C2, C3 and C4 of the spreading code assigned to information signal 1 to generate a respective product signal P1, P2, P3 and P4. In the example shown, the multiplying circuit is composed of multipliers 91, 92, 93 and 94. One input of the multipliers 91, 92, 93 and 94 is connected to the inputs Z1, Z2, Z3 and Z4, respectively, of spread-spectrum decoder 81 to receive channel signal X1, channel signal X2, channel signal X3 and channel signal X4, respectively. The other inputs of the multipliers 91, 92, 93 and 94 are connected to the outputs of spreading code source 90 to receive bit C1, bit C2, bit C3 and bit C4, respectively, of the spreading code assigned to spread-spectrum decoder 81. The outputs of multipliers 91, 92, 93 and 94 are connected to the inputs of analog summer 95. The output of the analog summer is connected to the input of threshold circuit 96. The output of the threshold circuit provides the recovered information signal 1 output by spread-spectrum decoder 81.

Multipliers 91, 92, 93 and 94 multiply the channel signal X1, the channel signal X2, the channel signal X3 signal and the channel signal X4, respectively, by bit C1, bit C2, bit C3 and bit C4, respectively, of the spreading code received from spreading code source 90. Multiplication of the channel signals X1, X2, X3 and X4 by multipliers 91, 92, 93 and 94 generates product signals P1, P2, P3 and P4, respectively. Analog summer 95 analog sums product signals P1, P2, P3 and P4 generated by multipliers 91, 92, 93 and 94, respectively, to generate a sum signal. The sum signal output by the analog summer in response to product signals P1, P2, P3 and P4 is an analog signal that replicates the logical states of information signal 1. Threshold circuit 96 receives the sum signal from analog summer 95 and subjects the sum signal to thresholding. This converts the sum signal into a digital signal that constitutes recovered information signal 1. Threshold circuit 96 outputs a bit in a −1 state when the sum signal it receives is less than a first threshold and outputs a bit in a +1 state when the sum signal it receives is greater than a second threshold, greater than the first threshold. The thresholding eliminates the noise that originates from the components in the channel signals resulting from encoding information signals 2-4.

The remaining spread-spectrum decoders 82-84 are structurally identical to spread-spectrum decoder 81 except for the spreading code provided by spreading code source 90. Spread-spectrum decoders 82-84 will therefore not be separately described.

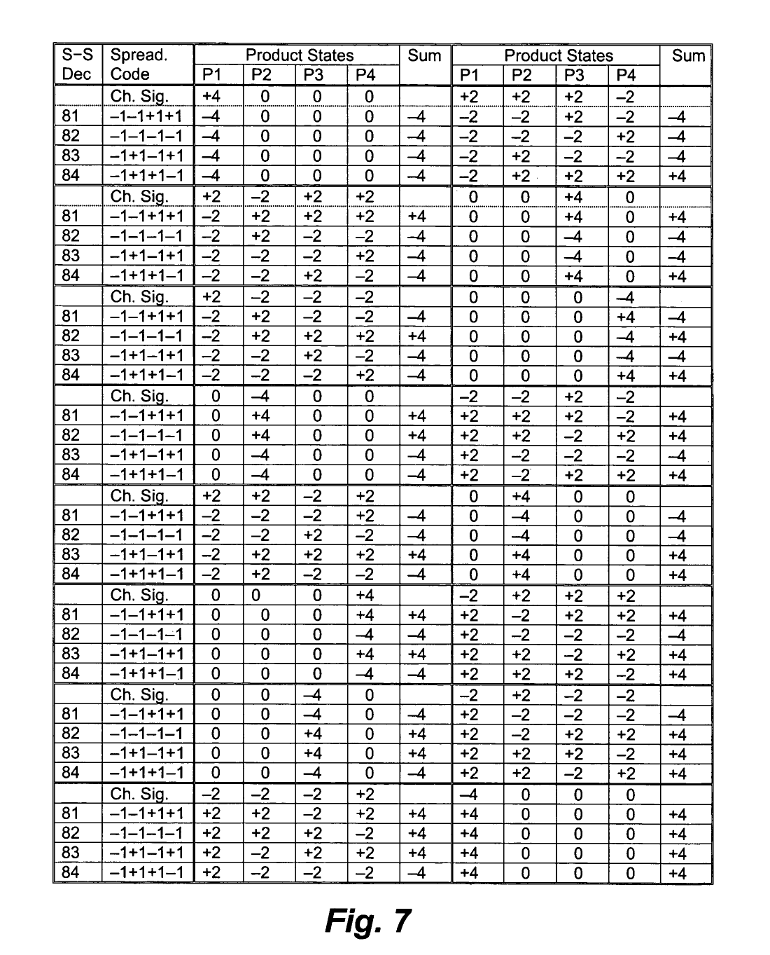

FIG. 7 is a table showing the operation of the spread-spectrum decoders 81-84 in response to all 16 possible combinations of the states of channel signal X1, channel signal X2, channel signal X3 and channel signal X4 output by optical receivers 76-79. FIG. 7 is divided by double lines into three columnar panels. The left-hand panel indicates the reference numerals of the spread-spectrum decoders in a column labelled S-S Dec., and the spreading codes assigned to each spread-spectrum encoder in a column labelled Spread. Code. The center panel shows the levels of the channel signals received by the spread-spectrum decoders and the corresponding levels of the product signals for each combination of channel signal levels representing states of information signals 1-4 in the range −1−1−1−1 through −1+1+1+1. The right-hand panel shows the levels of the channel signals received by the spread-spectrum decoders and the corresponding levels of the product signals for each combination of channel signal levels representing states of information signals 1-4 in the range +1−1−1−1 through +1+1+1+1. FIG. 7 is additionally divided by horizontal double lines into blocks of five rows. In the top row of each block, the levels of channel signals X1, X2, X3 and X4 are respectively shown in columns labelled P1, P2, P3 and P4, respectively. In the remaining four rows, the levels of the product signals P1, P2, P3, and P4 output by each of spread-spectrum decoders 81, 82, 83, and 84 are indicated in the columns labelled P1, P2, P3 and P4, respectively. Finally, each of the center and right-hand panels shows, in the column labelled Sum, the level of the sum signal generated in each of the spread-spectrum decoders 81-84 by the analog summer 95 analog summing product signals P1, P2, P3 and P4. The sum signal has two levels: −4 and +4. These levels correspond to the −1 state and the +1 state, respectively, of information signals 1-4 shown in FIG. 4.

In an example in which the levels of the channel signals X1, X2, X3 and X4 are {+2,+2,−2,+2}, FIG. 7 shows that the levels of the product signals P1, P2, P3 and P4 generated by multipliers 91, 92, 93 and 94 of spread-spectrum decoder 81 are {−2,−2,−2,+2}, those generated by multipliers 91, 92, 93 and 94 of spread-spectrum decoder 82 are {−2,−2,+2,−2} those generated by multipliers 91, 92, 93 and 94 of spread-spectrum decoder 83 are {−2,+2,+2,+2) and those generated by multipliers 91, 92, 93 and 94 of spread-spectrum decoder 84 are {−2,+2,−2,−2}. The resulting levels of the sum signals generated by analog summers 95 of spread-spectrum decoders 81, 82, 83 and 84 are {−4,−4,+4,−4}. These levels correspond to states of {−1,−1,+1,−1} of recovered information signals 1 through 4 respectively.

The levels of the channel signals X1-X4 shown in FIG. 7 assume that the communication system gain between the modulation inputs of optical transmitters 41-44 of transmitter 20 shown in FIG. 2 and the outputs of optical receivers 76-79 of receiver 60 shown in FIG. 5 is unity. The difference between the two levels of the sum signals output by analog summers 95 depends linearly on the gain of the communication system. Thus, the difference between the two levels of the sum signals will differ from that shown in embodiments in which the communication system has a gain different from unity.

In the above-described examples, analog summer 95 in each of the spread-spectrum decoders 81-84 sums product signals P1-P4 with a weight of 1. However, this is not critical to the invention. Analog summer may alternatively sum the product signals with a weight different from unity to generate the sum signal with a dynamic range compatible with the dynamic range requirements of threshold circuit 96. In the example described above, an embodiment of analog summer 95 that sums the product signals with a weight of ¼ will generate the sum signal with a dynamic range from −1 to +1.

An alternative embodiment of receiver 60 lacks optical receivers 76-79. In such alternative embodiment, channel signal distributor 64 operates in the optical domain and has its inputs connected to the outputs of demultiplexer 62. The outputs of the channel signal distributor are connected to the inputs Z1-Z4 of spread-spectrum decoders 81-84 as described above. Each of the spread-spectrum decoders additionally has an optical-to-electrical converter (not shown) and a level decoder (not shown) connected in series between each of the inputs Z1-Z4 and the inputs of multiplying circuit 86 (FIG. 6) or 286 (FIG. 10).

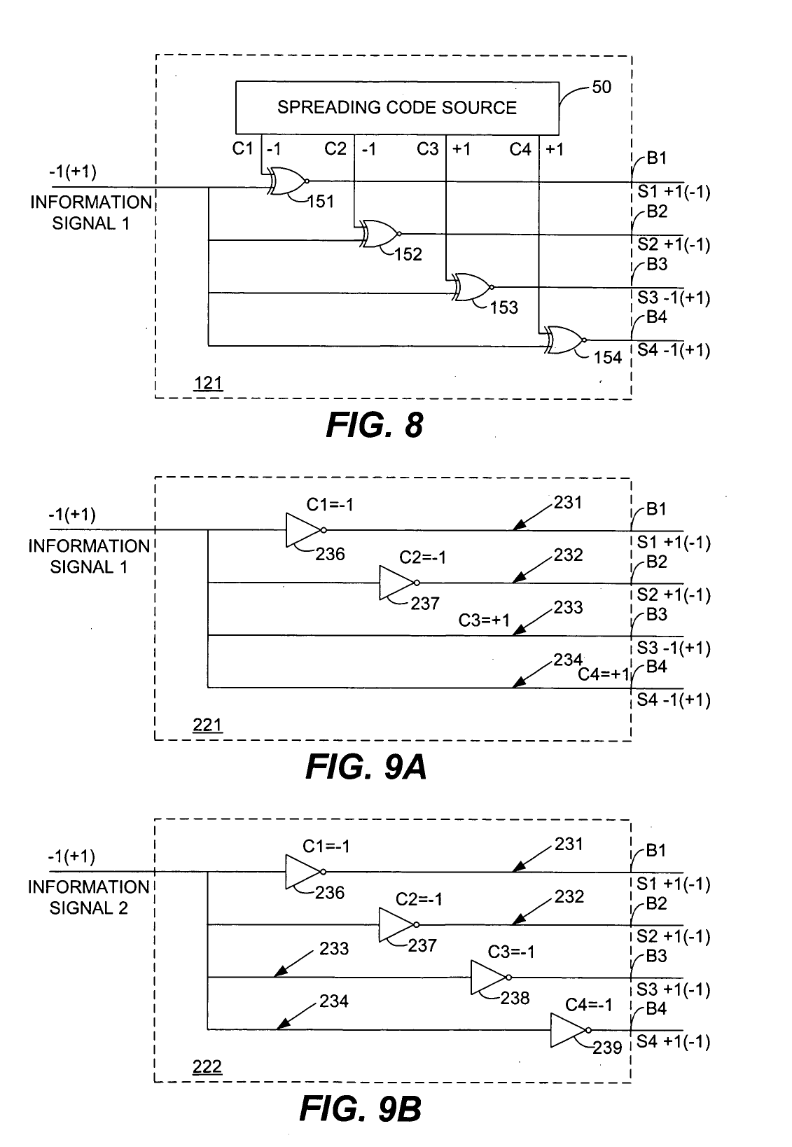

The multipliers shown in FIGS. 3A-3D may be implemented using exclusive-NOR (XNOR) gates. FIG. 8 is a block diagram of an alternative embodiment 121 of spread-spectrum encoder 21 shown in FIG. 3A.

In spread-spectrum encoder 121 shown in FIG. 8, multipliers 51, 52, 53 and 54 shown in FIG. 3A are implemented by exclusive-NOR gates 151, 152, 153 and 154. One input of each of XNOR gates 151, 152, 153 and 154 is connected to receive information signal 1. The other input of each of XNOR gates 151, 152, 153 and 154 is connected to the outputs of spreading code source 50 to receive a respective one of bits C1, C2, C3 and C4 of spreading code 1. The outputs of XNOR gates 151, 152, 153 and 154 are connected to outputs B1, B2, B3 and B4 of spread-spectrum encoder 121 to which they provide the coded signals S1, S2, S3 and S4, respectively, output by spread-spectrum encoder 121.

FIG. 8 also shows two consecutive states of the coded signals S1-S4 that spread-spectrum encoder 121 generates in response to two consecutive bits of information signal 1. The consecutive bits are in a −1 state and a +1 state, respectively. The bit of the information signal 1 in the +1 state and the states of the coded signals generated in response to the bit of information signal 1 in the +1 state are shown in parentheses.

Exclusive-OR gates may be used in spread-spectrum encoder 121 instead of the exclusive-NOR gates shown, and the term exclusive-NOR as used herein will be understood to encompass exclusive-OR.

Alternative embodiments of spread-spectrum encoders 22, 23 and 24 (FIGS. 3B, 3C and 3D, respectively) are identically structured to spread-spectrum encoder 121 shown in FIG. 8, except that XNOR gates 151, 152, 153 and 154 receive different spreading codes from spreading code source 50.

In the embodiments described above, the spread-spectrum encoders 21-24 and spread-spectrum decoders 81-84 each include a spreading code source that provides the assigned spreading code to the multipliers or, in the case of the spread-spectrum encoders, to the XNOR gates that perform multiplication. This arrangement allows the spreading code assigned to encode and decode a given information signal to be changed simply by changing the spreading code stored in the spreading code source of the spread-spectrum encoder and the spread-spectrum decoder that encode and decode the information signal. Embodiments in which an ability to change the spreading code used to encode a given information signal is not needed can incorporate the alternative spread-spectrum encoders shown in FIGS. 9A and 9B and the alternative spread-spectrum decoder shown in FIG. 10.

FIG. 9A is a block diagram of an alternative embodiment 221 of spread-spectrum encoder 21 shown in FIG. 3A and FIG. 9B is a block diagram of an alternative embodiment 222 of spread-spectrum encoder 22 shown in FIG. 3B. Spread-spectrum encoders 221 and 222 are each composed of four parallel signal paths 231, 232, 233 and 234. The signal paths are interconnected at one end, where they are additionally connected to receive the respective information signal. The other ends of signal paths 231, 232, 233 and 234 are connected the outputs B1, B2, B3 and B4, respectively. The information signal on each of the signal paths is encoded by a different one of the bits C1, C2, C3 and C4 of the spreading code assigned to the spread-spectrum encoder to generate the coded signals S1, S2, S3 and S4, respectively. An inverter is connected in series with those of the signal paths for which the respective bit of the spreading code is in the −1 state.

The bits of spreading code 1 assigned to spread-spectrum encoder 221 shown in FIG. 9A are {C1=−1, C2=−1, C3=+1, C4=+1}. The bits of spreading code 1 corresponding to outputs B1 and B2 are in the −1 state. Accordingly, an inverter 236 is connected in series with signal path 231 connected to output B1 and an inverter 237 is connected in series with signal path 232 connected to output B2. The bits of spreading code 1 corresponding to outputs B3 and B4 are in the +1 state, so no inverters are connected in series with signal paths 233 and 234 connected to outputs B3 and B4, respectively. The bits of spreading code 2 assigned to spread-spectrum encoder 222 shown in FIG. 9B are {C1=−1, C2=−1, C3=−1, C4=−1}. The bits of spreading code 2 corresponding to outputs B1, B2, B3 and B4 are all in the −1 state. Accordingly, an inverter 236 is connected in series with signal path 231 connected to output B1, an inverter 237 is connected in series with signal path 233 connected to output B2, an inverter 238 is connected in series with signal path 234 connected to output B3 and an inverter 239 is connected in series with signal path 235 connected to output B4. An alternative embodiment of spread-spectrum encoder 23 (FIG. 3C) has inverters connected in series with signal paths 231 and 233, and an alternative embodiment of spread-spectrum encoder 24 (FIG. 3D) has inverters connected in series with signal paths 231 and 234.

FIGS. 9A and 9B also show two consecutive states of the coded signals S1-S4 that spread-spectrum encoders 221 and 222 generate in response to two consecutive bits of information signal 1 and information signal 2, respectively. The consecutive bits are a −1 state and a +1 state. The bits of the information signals in the +1 state and the states of the coded signals generated in response to the bits of the information signals in the +1 state are shown in parentheses.

FIG. 10 is a block diagram of an alternative embodiment 281 of spread-spectrum decoder 81 of the wavelength spread-spectrum receiver shown in FIG. 5. Elements of spread-spectrum decoder 281 that correspond to elements of spread-spectrum decoder 81 described above with reference to FIG. 6 have the same reference numerals and will not be described again in detail.

In spread-spectrum decoder 281, multiplying circuit 286 is connected to the inputs Z1, Z2, Z3 and Z4 to receive the channel signals X1, X2, X3 and X4 from transmission channels 71, 72, 73 and 74, respectively, and performs the function of multiplying each channel signal by a respective bit C1, C2, C3 and C4 of the spreading code assigned to information signal 1 to generate a respective product signal P1, P2, P3 and P4. In the example shown, multiplying circuit 286 is composed of four parallel signal paths 241, 242, 243 and 244. At one end, signal paths 241, 242, 243 and 244 are connected to inputs Z1, Z2, Z3 and Z4 to receive channel signals X1, X2, X3 and X4, respectively. The other ends of signal paths 241, 242, 243 and 244 are connected to the inputs of analog summer 95 to which they deliver the product signals P1, P2, P3 and P4, respectively. The channel signal on each of the signal paths 241, 242, 243 and 244 is multiplied by a different one of the bits C 1, C2, C3 and C4, respectively, of spreading code 1 assigned to spread-spectrum decoder 281 by an inverter connected in series with those of signal paths 241, 242, 243 and 244 for which the respective bit of the spreading code is in the −1 state.

The bits of spreading code 1 assigned to spread-spectrum decoder 281 shown in FIG. 10 are {C1=−1, C2=−1, C3=+1, C4=+1}. The bits of spreading code 1 corresponding to channel signals X1 and X2 are in the −1 state. Accordingly, an inverter 246 is connected in series with signal path 241 connected to input Z1 and an inverter 247 is connected in series with signal path 242 connected to input Z2. The bits of spreading code 1 corresponding to channel signals X3 and X4 are in the +1 state, so no inverters are connected in series with signal paths 243 and 244 connected to inputs X3 and X4, respectively. An alternative embodiment of spread-spectrum decoder 82 (FIG. 2) has inverters connected in series with signal paths 241, 242, 243 and 244, an alternative embodiment of spread-spectrum decoder 83 has inverters connected in series with signal paths 241 and 243, and an alternative embodiment of spread-spectrum encoder 84 has inverters connected in series with signal paths 241 and 244.

In the embodiments described above, the information signals have states of −1 and +1 and the spreading codes have states of −1 and +1. However, this is not critical to the invention. The information signals may alternatively have states of 0 and 1 and the spreading codes may alternatively have states of 0 and 1. In an embodiment of transmitter 20 in which the information signals and spreading codes have states of 0 and 1, embodiments of spread-spectrum encoders 21-24 use XNOR gates to multiply such information signals with such spreading codes as described above. In such embodiments, analog summers 31-34 are structured to sum the 0 states of the coded signals with a weight of −1 and the 1 states of the coded signals in with a weight of +1. In an embodiment of receiver 60 in which the information signals and spreading codes have states of 0 and 1, spread-spectrum decoders 81-84 multiply the channel signals by the spreading codes by inverting those of the channel signals for which the corresponding bit of the spreading code is a zero 0, and do not invert those of the channel signals for which the corresponding bit of the spreading code is a 1. Additionally, thresholding circuit 96 in each of the spread-spectrum decoders 81-84 is configured to output the recovered information signal with states of 0 and 1.

The examples described above are highly simplified in that four information signals are encoded using four mutually-orthogonal spreading codes each of four bits and are transmitted via four transmission channels. The above-described figure of merit of this simplified example is no higher than that of a conventional multi-channel communication system in which each information signal is transmitted in a respective transmission channel. However, the simplified example is potentially more reliable than a conventional multi-channel communication system in that all information signals can be recovered at the receiver even if one of the transmission channels fails.

A practical embodiment of the wavelength spread-spectrum communication system uses more than four transmission channels and, hence, spreading codes of more than four bits. Even with spreading codes of more than four bits, the number of purely orthogonal spreading codes is equal to the number of bits. Consequently, a wavelength spread-spectrum communication system using purely orthogonal spreading codes is only capable of transmitting the same number of information signals as the number of transmission channels. Such embodiments provide an increase in reliability, as described above, but no increase in the figure of merit compared with a conventional multi-channel communication system. However, by additionally or alternatively using quasi-orthogonal spreading codes, of which more exist than the number of bits, a wavelength spread-spectrum communication system can transmit more information signals than the number of transmission channels. Such a communication system has a higher figure of merit than a conventional multi-channel communication system.

Embodiments of the wavelength spread-spectrum communication system described above may be constructed from one or more of discrete components, small-scale or large-scale integrated circuits, suitably-configured application-specific integrated circuits (ASICs) and other suitable hardware. Alternatively, embodiments of the apparatus and the modules thereof may be constructed using a digital signal processor (DSP), microprocessor, microcomputer, computer or other programmable device with internal or external memory operating in response to a program fixed in a computer-readable medium. A programmable device, such as a DSP, a microprocessor, microcomputer or computer, capable of executing a program will be referred to herein as a computer.

In computer-based embodiments of the wavelength spread-spectrum communication, one or more of the modules described above may be ephemeral, and may only exist temporarily as the program executes. In such embodiments, the program is conveyed to the computer on which it is to run by embodying the program in a suitable computer-readable medium, such as a set of floppy disks, a CD-ROM, a DVD-ROM, flash memory or other memory device. Alternatively, the program could be transmitted to such computer by a suitable data link and be stored in a memory device in the computer.

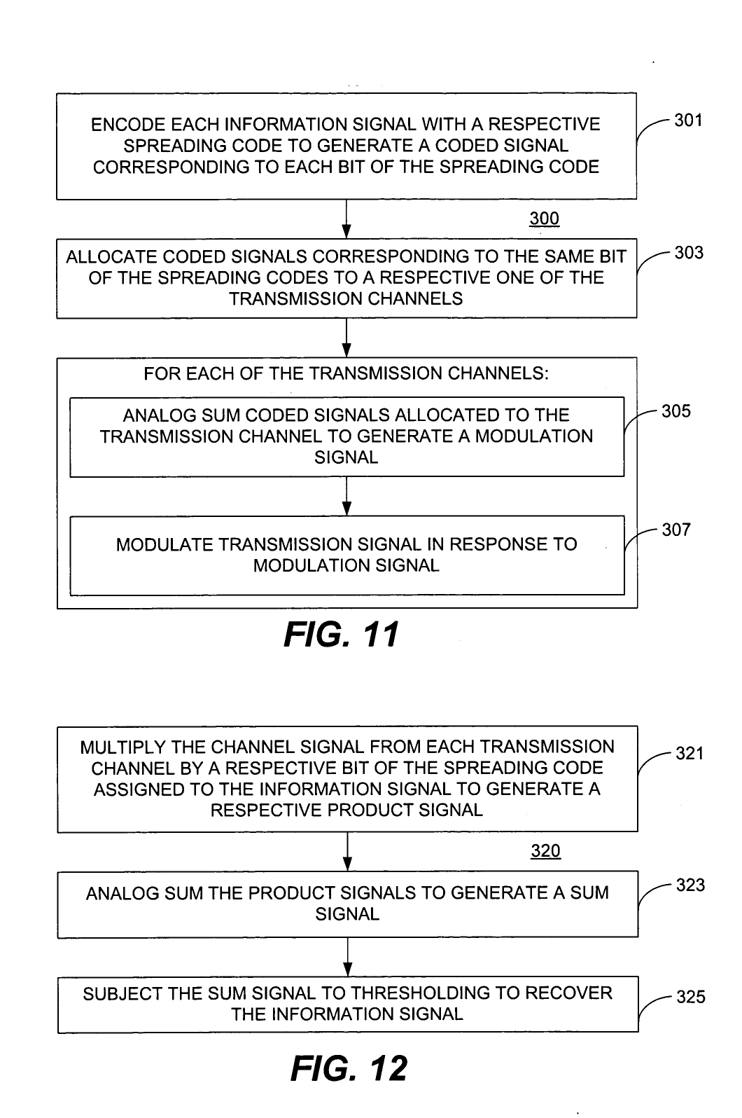

FIG. 11 is a flow chart of an embodiment 300 of a method in accordance with the invention for transmitting information signals via multiple transmission channels. In the method, in block 301, each information signal is encoded with a respective spreading code to generate a coded signal corresponding to each bit of the spreading code. The spreading codes used to encode the information signals are mutually different. In block 303 the coded signals corresponding to the same bit of the spreading codes are allocated to a respective one of the transmission channels. Blocks 305 and 307 are performed in each of the transmission channels. In block 305 the coded signals allocated to the transmission channels are analog summed to generate a modulation signal. In block 307, a transmission signal is modulated in response to the modulation signal.

In an embodiment, the spreading codes are mutually orthogonal. In another embodiment, the spreading codes are mutually quasi-orthogonal.

In an embodiment, each information signals is encoded by multiplying it by each bit of the respective spreading code. Each multiplication may be performed by exclusively-NORing the information signal with the bit of the respective spreading code. In another embodiment, each spreading code comprises bits each in one of a first state and a second state, e.g., bits each in one of a −1 state and a +1 state. Each information signal is encoded by outputting the information signal as the coded signal for each bit of the spreading code in the first state and inverting the information signal and outputting the inverted information signal as the coded signal for each bit of the spreading code in the second state.

FIG. 12 is a flow chart of an embodiment 320 of a method in accordance with the invention for recovering information signals from channel signals received via respective transmission channels. The channel signals have been generated by encoding the information signals with respective spreading codes. The method is performed for each of the information signals. In the method, in block 321, the channel signal from each of the transmission channels is multiplied by a respective bit of the spreading code assigned to the information signal to generate a respective product signal. In block 323, the product signals are summed to generate a sum signal. In block 325, the sum signal is subject to thresholding to recover the information signal.

In an embodiment, each spreading code comprises bits each in one of a first state and a second state. Each channel signal is multiplied by outputting the channel signal as the product signal for each bit of the spreading code in the first state and inverting the channel signal and outputting the inverted channel signal as the product signal for each bit of the spreading code in the second state.

In an embodiment, the spreading codes are mutually orthogonal. In another embodiment, the spreading codes are mutually quasi-orthogonal.

Orthogonal spreading codes are preferred because they have a cross-correlation of zero. This means that the sum signal from which each information signal is recovered is free of noise contributions originating from the other information signals. However, the number of orthogonal spreading codes of a given number of bits is limited, as described above. If quasi-orthogonal spreading codes are used, the sum signal from which each information signal is recovered includes noise contributions originating from the other information signals. However, such noise contributions are discarded by the thresholding applied to the sum signal provided that their level is low enough. Using quasi-orthogonal spreading codes increases the number of useable spreading codes, which enables the communication system to transmit more information signals than the number of transmission channels. Welch Bound Equality (WBE) codes can be used as the spreading codes to increase the number of information signals that can be transmitted beyond one per transmission channel. The manner in which WBE codes can be generated is known in the art. The increase in transmission capacity provided by using WBE codes as the spreading codes is limited by the lower bound of the WBE codes for cross-correlation, as is also known in the art.

While the invention has been described with reference to exemplary embodiments, the invention is not limited to the precise embodiments described, and is defined exclusively by the appended claims and their equivalents.

1. A method for transmitting information signals via multiple transmission channels, the method comprising:
encoding each information signal with a respective spreading code to generate a coded signal corresponding to each bit of the spreading code, the spreading codes being mutually different;
allocating the coded signals corresponding to the same bit of the spreading codes to a respective one of the transmission channels; and
in each of the transmission channels:
analog summing the coded signals allocated thereto to generate a modulation signal, and
modulating a transmission signal in response to the modulation signal.

2. The method of claim 1, in which the spreading codes are mutually orthogonal.

3. The method of claim 1, in which the spreading codes are mutually quasi-orthogonal.

4. The method of claim 1, in which the encoding comprises multiplying the information signal by each bit of the respective spreading code to generate the corresponding coded signal.

5. The method of claim 4, in which the multiplying comprises exclusively-NORing the information signal with the bit of the respective spreading code.

6. The method of claim 1, in which:
each spreading code comprises bits each in one of a first state and a second state; and
the encoding comprises:
for each bit of the spreading code in the first state, outputting the information signal as the coded signal corresponding to the bit of the spreading code, and
for each bit of the spreading code in the second state, inverting the information signal and outputting the inverted information signal as the coded signal corresponding to the bit of the spreading code.

7. A method for recovering information signals from channel signals received via respective transmission channels, the channel signals resulting from encoding the information signals with respective spreading codes, the method comprising, for each of the information signals:
multiplying the channel signal from each of the transmission channels by a respective bit of the spreading code assigned to the information signal to generate a respective product signal;
analog summing the product signals to generate a sum signal; and
subjecting the sum signal to thresholding to recover the information signal.

8. The method of claim 7, in which the spreading codes assigned to the information signals are mutually orthogonal.

9. The method of claim 7, in which the spreading codes assigned to the information signals are mutually quasi-orthogonal.

10. The method of claim 7, in which:
each spreading code comprises bits each in one of a first state and a second state; and
the multiplying comprises:
for each bit of the spreading code in the first state, outputting the channel signal as the respective product signal, and
for each bit of the spreading code in the second state, inverting the channel signal and outputting the inverted channel signal as the respective product signal.

11. Apparatus for transmitting information signals via multiple transmission channels, the apparatus comprising:
for each of the information signals, a spread-spectrum encoder comprising coded signal outputs and operable to encode the information signal with a respective spreading code to provide a coded signal corresponding to each bit of the spreading code at a respective one of the coded signal outputs, the spreading codes being mutually different;
a signal allocator connected to the coded signal outputs of the spread-spectrum encoders, the signal allocator structured to allocate the coded signals corresponding to the same bit of the spreading codes to a respective one of the transmission channels; and
in each of the transmission channels:
an analog summer comprising an output, and inputs connected to the signal allocator to receive therefrom the coded signals allocated to the transmission channel, and
a transmitter comprising a modulation input connected to the output of the analog summer.

12. The apparatus of claim 11, in which the spreading codes are mutually orthogonal.

13. The apparatus of claim 11, in which the spreading codes are mutually quasi-orthogonal.

14. The apparatus of claim 11, in which:
the transmitter additionally comprises an output; and
the apparatus additionally comprises a multiplexer comprising inputs connected to the outputs of the transmitters, and an output coupled to a transmission medium.

15. The apparatus of claim 11, in which the transmitters are optical transmitters and the transmission medium comprises an optical fiber.

16. The apparatus of claim 15, in which the transmitters are wireless transmitters.

17. The apparatus of claim 11, in which the spread-spectrum encoder comprises:
a spreading code source comprising outputs each providing a respective bit of the spreading code; and
for each bit of the spreading code, a multiplier comprising an input connected to receive the information signal, an input connected to a respective one of the outputs of the spreading code source, and an output that provides a respective one of the coded signals.

18. The apparatus of claim 11, in which the spread-spectrum encoder comprises:
a spreading code source comprising outputs each providing a respective bit of the spreading code; and
for each bit of the spreading code, an exclusive-NOR gate comprising an input connected to receive the information signal, an input connected to a respective one of the outputs of the spreading code source, and an output that provides a respective one of the coded signals.

19. The apparatus of claim 11, in which:
each spreading code comprises bits each in one of a first state and a second state; and
the spread-spectrum encoder comprises:
for each bit of the spreading code, an information signal input, a coded signal output and a signal path interconnecting the information signal input and the coded signal output, and
for each bit of the spreading code in the second state, an inverter in series with the signal path.

20. Apparatus for recovering information signals from channel signals received via respective transmission channels, the channel signals resulting from encoding the information signals with respective spreading codes, the apparatus comprising a spread-spectrum decoder for each information signal, the spread-spectrum decoder comprising:
multiplying means, connected to receive the channel signals from the transmission channels, for multiplying each channel signal by a respective bit of the spreading code assigned to the information signal to generate a respective product signal; and
an analog summer comprising an output, and inputs connected to receive the product signals from the multiplying means; and
a threshold circuit comprising an input connected to the output of the analog summer and additionally comprising an output providing the information signal.

21. The apparatus of claim 20, in which the spreading codes are mutually orthogonal.

22. The apparatus of claim 20, in which the spreading codes are mutually quasi-orthogonal.

23. The apparatus of claim 20, in which:
the spread-spectrum decoder additionally comprises a spreading code source comprising outputs each providing a respective bit of the spreading code; and
the multiplying means comprises a multiplier for each of the transmission channels, the multiplier comprising an input connected to receive the channel signal from the transmission channel, an input connected to a respective one of the outputs of the spreading code source, and an output that provides a respective one of the product signals.

24. The apparatus of claim 20, in which:
each spreading code comprises bits each in one of a first state and a second state; and
the multiplying means comprises:
for each bit of the spreading code, a channel signal input connected to receive the channel signal from the transmission channel, a product signal output that provides a respective one of the product signals, and a signal path interconnecting the channel signal input and the product signal output, and
for each bit of the spreading code in the second state, an inverter in series with the signal path.

25. The apparatus of claim 20, additionally comprising:
an optical receiver in each of the transmission channels, the optical receiver operable to derive the channel signal for the transmission channel from a single-wavelength optical signal; and
a channel signal distributor connected between the optical receivers and the spread-spectrum decoders.
